(19) United States
(12) Patent Application Publication
(10) Pub. No.: US 2003/0120517 A1
(43) Pub. Date: Jun. 26, 2003

(54) Dialog data recording method

(76) Inventors: Masataka Eida, Kanagawa (JP); Nobuyuki Hosoi, Saitama (JP); Mamoru Sakaki, Kanagawa (JP); Masako Shimomura, Kanagawa (JP); Genji Inada, Kanagawa (JP); Noriyasu Asaki, Kanagawa (JP)

Correspondence Address: ROBIN BLECKER & DALEY, 2ND FLOOR, 330 MADISON AVENUE, NEW YORK, NY, 10017, US

(21) Appl. No.: 10/308,433

(22) Filed: Dec. 3, 2002

(30) Foreign Application Priority Data
Dec. 7, 2001 (JP) 374302/2001 (PAT.

(51) Int. Cl. G06F 17/60

(52) U.S. Cl. 705/3; 709/213; 709/246

(57) ABSTRACT

In a system in which a computer terminal of a doctor, capable of entering audio data and an image and of data printing, is capable of communicating with a server managed by a third person and having a large-capacity memory apparatus, dialog data, containing an image and audio data in a dialog between the doctor and a patient, are transmitted from the computer terminal of the doctor to the server for storage in the large-capacity memory apparatus, then the audio data in the dialog data are recognized and converted into text data, clinical report data are generated from the text data, and the clinical report data are printed by the computer terminal of the doctor to generate a clinical report. The clinical report is shown to the patient and is given an approving signature, which is stored in correlation with the dialog data.

### BACKGROUND OF THE INVENTION

1. Field of the Invention

The present invention relates to a dialog data recording method for recording and storing a dialog such as of a doctor and a patient or of a lawyer and a client.

2. Related Background Art

For example in the medical field, medical deeds such as a medical interview between a doctor and a patient, a diagnosis, a treatment (medicine prescription) and the like are recorded on a clinical report handwritten by the doctor.

Conventionally, the clinical report in a hospital has been a memorandum in nature, principally for leaving a record on symptoms of the patient, diagnosis thereof, and treatment and medicine prescription therefor, thereby assisting the treatment of the doctor. Stated differently, it has been observable only to the doctor and not available to the patient. Consequently the clinical report has been prepared according to the intention of the doctor, and a detailed recording has not been necessary.

However, with the recent increase in lawsuits on the medical treatment and with the clinical reports becoming used as evidences in the lawsuits, it is being required to make a detailed description on the clinical report, in order to testify necessity and properness of the medicine prescription and the treatment.

Also as the patient is now enabled to select the medical treatment with the recent spreading of the informed consent, instances of lawsuit by the family or the relatives of the patient against the doctor or the hospital after the patient's death are increasing, and the clinical report containing detailed description of the content of medical diagnosis is becoming an important evidence in such lawsuits.

However, it has been difficult to make a detailed description on the clinical report for a doctor who deals with a large number of patients. Consequently, there has been desired a method capable of solving such issue from the standpoints of both the doctor and the patient.

Consequently, there is conceived a method of executing speech recognition on the dialog between the doctor and the patient and immediately printing it as a detailed clinical report.

In relation to such dialog recording, there is proposed a conference minute preparation supporting apparatus. Such apparatus records the speeches of plural persons in a conference, changes the content of such speeches into a sentence by speech recognition and displays such sentence on a board of a conference room, thereby accelerating the proceeding of the conference and realizing a smooth preparation of a minute of the conference. There is also conceived a system of preparing a minute by speech recognition of a dialog, utilizing for example a mobile terminal (mobile telephone).

There are also being developed a technology of eliminating, from the information obtained by the speech recognition, unnecessary words registered in advance in an unnecessary word table, thereby summarizing the content of a conference or a dialog, and a technology of applying a digital watermark technology to the information obtained by the speech recognition, thereby making forging of the data difficult.

FIG. 9 shows the schematic configuration of a conventional minute preparing system. In this system, when data on a conference are entered from an image input unit 205, an audio input unit 206 and a data input unit 207 (such as a keyboard), a personal computer conference processing unit 208 and an audio text conversion processing unit (speech recognition unit) 209 process such data in image data and im audio data separately, and the audio text portion is prepared as a conference minute by a conference minute creation unit 210 and is made observable to related persons even at the outside, through an internet 8 via an interface.

FIG. 10 shows a flow chart of a process sequence in the minute preparing system shown in FIG. 9. Upon detection of an audio input (step S1001), image data are fetched and given an ID (step S1002), and audio text are transmitted to the minute preparing unit for minute preparation (steps S1003-S1004). As explained in the foregoing, it is already almost realized to convert the content of a dialog or a conference of people into sentences, to summarize and print such sentences.

It is therefore conceivable to apply such conventional technology to a dialog of a doctor and a patient. However, such conventional technology is insufficient in reducing the dialog of the doctor and the patient into a clinical report which has a nature of an official document.

The limitations in such application will be listed below:

1) A mere conversion of the dialog into sentences by speech recognition and a printout thereof do not guarantee the content and are difficult to be used as an evidence;

2) In a clinical report, there cannot be precisely written items required as base data for the payment of a treatment fee, including a diagnosis fee, a medicine prescription fee and an inspection fee etc.;

3) A clinical report, also serving as a reference data recording and storing a recovery, a cure or a change in symptoms in the treatment of the patient, has to express and record such states in details and in a compact manner;

4) As a patient is not necessarily treated always by a same doctor or in a same hospital, it is desirable that the clinical report is usable in plural hospitals, but such utilization is not achievable in the aforementioned conventional technologies;

5) For the speech recognition, and the preparation of printed data by conversion, there are required preparation of a database based on technical terms, a satisfactory and secure speech recognition system capable of excluding noises, and a high-speed computer processing system, but such system is economically difficult to maintain by a personally operating doctor or a hospital in a remote site;

6) In case of a contagious disease such as cholera, such information has to be immediately informed to a health center in charge of the district, but such information, unless confirmed, may impose a significant economic damage to the home of the patient or to the surrounding area.

Consequently there arise mutually contradicting requirements of maintenance of confidentiality and prompt communication. Stated differently, unless the disease is confirmed as a disease designated by law, the communication of information cannot be made and the confidentiality of such information has to be cautiously maintained.

On the other hand, in case the confidentiality is maintained excessively to result in an infection and a damage in other areas, there results a danger of being exposed to a request for indemnification of the damage;

7) Consideration or knowledge based on the personal ability of the doctor cannot be written in a state maintaining the confidentiality. For example, to specify a disease, a focus or an infected part thereof, also to specify a cause thereof from a slight symptom or behavior of the patient and to select a suitable treatment belong to the ability of the doctor based on the personal experience thereof, so-to-speak know-how of the doctor.

Such facts cannot consequently be described openly, and facts based on the experience cannot be proved objectively. It is not possible, therefore, to describe such facts openly in the clinical report not to disclose them to the patient or the family thereof under the concept of informed concept.

However, since the doctor executes the treatment based on such consideration, it is necessary to record such facts somewhere, in order to prepare for an eventual medical accident or a medical lawsuit.

### SUMMARY OF THE INVENTION

In consideration of the foregoing, an object of the present invention is to provide a dialog data recording method capable of recording and storing a dialog of persons as an evidence.

According to one aspect, the present invention which achieves such object relates to a dialog data recording method in a system, in which each personal computer terminal capable of entering audio data and image data and of printing can communicate with a server having a large-capacity memory apparatus and managed by a third person, the method comprising steps of transmitting dialog data including an image input and an audio input in a dialog of the above-mentioned person with another person from the computer terminal of the above-mentioned person to the server for storage in the large-capacity memory apparatus, recognizing and converting the audio input of the dialog data into text data, generating script data from the text data, and printing such script data in the computer terminal of the above-mentioned person.

Other objectives and advantages thereof besides those discussed above shall be apparent to those skilled in the art from the description of a preferred embodiment of the invention which follows. In the description, reference is made to accompanying drawings, which form a part hereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a schematic view showing the configuration of a basic system embodying the present invention;

FIG. 2 is a view showing a configuration of script data of a representative clinical report;

FIG. 3, which is comprised of FIGS. 3A and 3B, is a flow chart of a basic system;

FIG. 4, which is comprised of FIGS. 4A and 4B, is a flow chart of the system in case a secret file is attached;

FIG. 5 is a schematic view showing a configuration for a partial image deletion and an obscuring process;

FIG. 6 is a schematic view showing a configuration of a system in case an enciphering apparatus utilizing the internet;

FIGS. 7A and 7B are flow charts showing the sequence of a privacy process;

FIG. 8 is a flow chart for explaining a data flow;

FIG. 9 is a view showing a conventional conference minute preparation system; and

FIG. 10 is a flow chart showing a conventional sequence of preparing a conference minute.

### DESCRIPTION OF THE PREFERRED EMBODIMENTS

In the following, a preferred embodiment of the present invention will be explained in detail, with reference to the accompanying drawings. In these drawings, a specified person 1 is a specified and qualified individual such as a doctor, and an unspecified person 2, making a dialog with the person 1, is a patient of the doctor.

A computer 3 used by the doctor 1 is provided with an image pickup camera 5, an audio pickup microphone 6, a switch 4 for activating the camera 5 and the microphone 6, and a printer 7.

The computer 3 is connected through an internet 8 to a service mechanism 9 operated by a third person. In the service mechanism 9, there are provided a speech recognition system for converting audio data of the dialog into characters, a processing server computer (hereinafter simply called server) 10 capable of a high-speed processing for converting an image and the dialog, converted into characters, into script data 55 of a predetermined format, and a management computer 12 for confirming the operation status of the server 10.

The server 10 is provided therein with a large-scale recording apparatus, and the audio data of the above-mentioned dialog and the image data showing a situation of diagnosis are recorded on a magnetic disk or an optical disk 11.

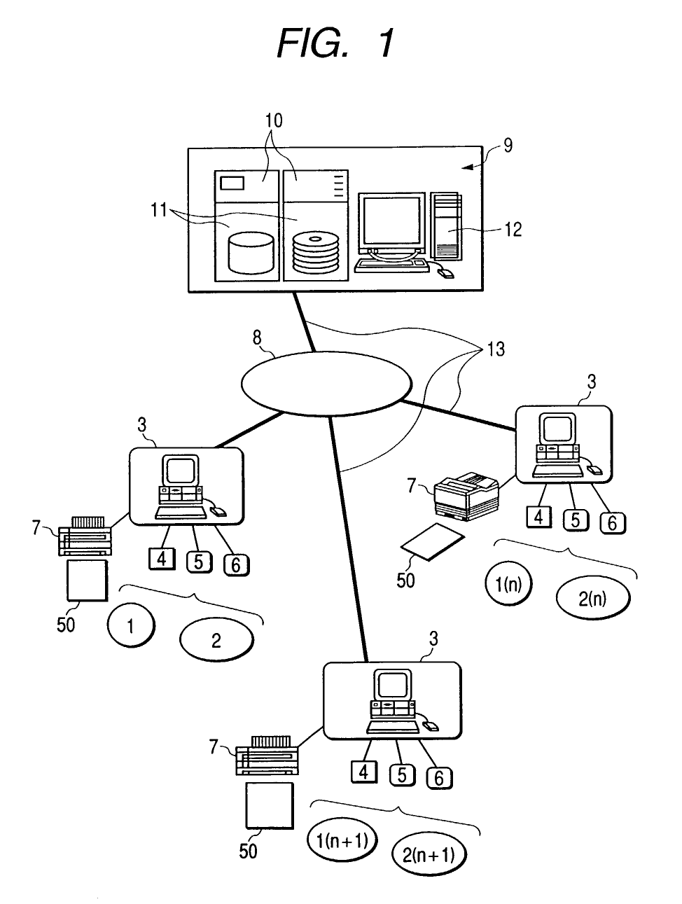

The specified person (doctor) 1 is not limited to one, but, as shown in FIG. 1, plural specified persons (doctors) 1 are connected to the server 10 of the service mechanism 9 by the internet 8.

Basically, an internet network in an enciphered state is constructed between the server 10 and the computer 3. The communication is executed for example through a VPN enciphering communication apparatus such as Fort Knox of Alcatel Inc., U.S.A., or Mucho-E/EV of Furukawa Denko Co., Ltd.

Data delivery to the person 2 (patient) is preferably executed by a transmission utilizing a VPN remote client software. The computer 3 operated by the doctor 1 desirably has a clock frequency of 200 MHz or higher, an internal memory of 128 Mbyte or higher, and a hard disk capacity of 2 Gbyte or higher, and is based an operating system (OS) of Windows (registered trade name) 95 or a later version.

Also the browser software is desirably Internet Explorer V4 or Netscape V4.6 or a later version, and the graphic environment is preferably OGL (Open Graphix).

Further, the audio microphone 6 and the imaging camera 5 are desirably matched with the above-described specifications. The specific operations of the system will be explained in the following by an example.

In case a physician 1 is visited for diagnosis by a patient 2 having an abdominal pain, the doctor 1 and the patient 2 are seated face to face. The doctor 1 starts up the computer 3 to prepare for receiving the aforementioned clinical report preparation service.

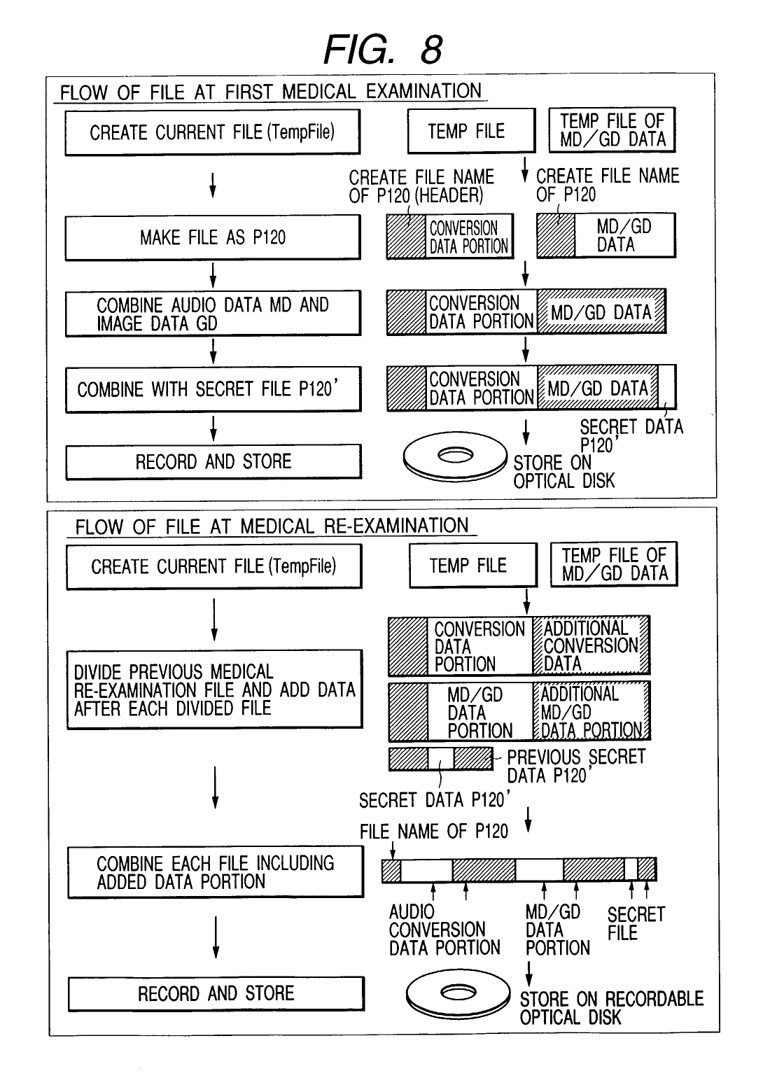

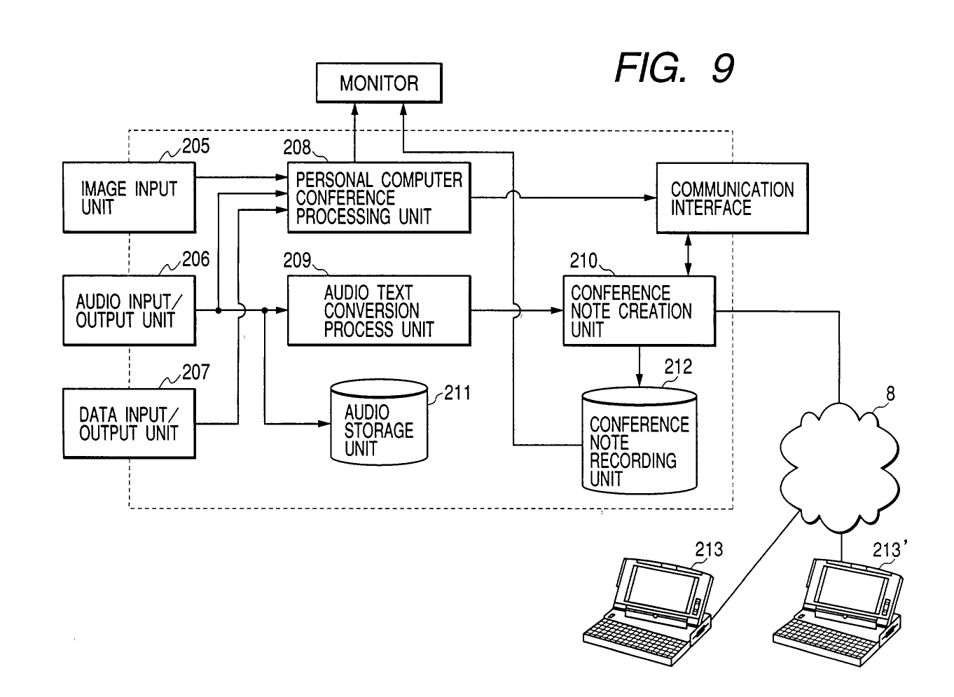

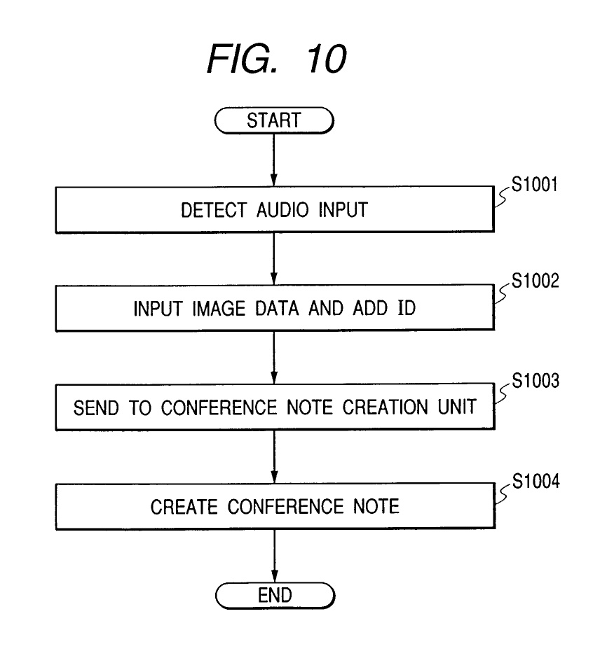

FIG. 8 is a flow chart showing a file process sequence. The doctor 1 informs the patient 2 of start of a diagnosis, and turns on the switch 4. The audio microphone 6 and the camera 5 are activated, and start transmission of audio data (OD) and image data (GD) from time to time.

At this point, the doctor 1 introduces himself, thereby being registered as a specified person through the internet 8. Then, the patient 2 declares a name, a date of birth, an address, a telephone number etc.

It is thus recognized that the specified person 1 is the doctor 1 and that a counterpart thereof in the dialog is the patient 2, and the data of the doctor 1 are registered as specified personal data (TD) and the data of the patient 2 (Mr. OO) as the data of the dialog counterpart (TBD).

The state at this point is still a current file of which file name is not yet specified, as shown in FIG. 8. The aforementioned data TD, TBD and speech recognized data are stored therein. Also, audio data (OD) and image data (GD) are temporarily stored in another related current file (Temp. file).

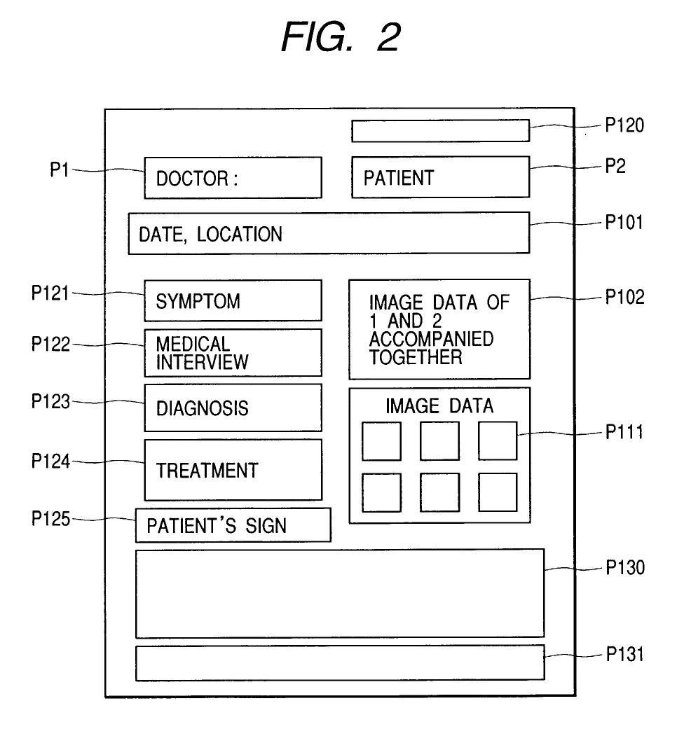

These data (TD, TBD) are used for forming script data of the clinical report 50, and are to be placed in positions P1 and P2 in FIG. 2. In case the patient 2 cannot speak out, the doctor 1 may speak out the name, date of birth, address etc. of the patient 2 and may request a confirmation by the patient 2.

A reply for such confirmation is for example “Yes” or “That is correct”, whereupon the patient 2 can be specified. Otherwise the doctor 1 may enter the name etc. of the patient 2 by a key input.

In response, a file name P120 (header) is generated from the name of the patient 2, and the data thereof are stored in the server 10. Up to this point, the data are stored, in the server 10, in a current file under a temporary name, but, at this point, the data are turned into a formal file under the name P120 of the patient 2, and the dialog thereafter is also recorded under the file name P120.

However, the file name P120 is also given an identification number of the computer 3 and a time, in order to avoid confusion with another patient of an identical name or with a case in which the patient 2 is treated by another hospital or another doctor 1′.

At this state, the server 10 analyzes the voiceprint of the speeches of the doctor 1 and the patient 2, thereby initiating to specifying and classifying of the two speakers. In case the speech of the patient 2 is limited and the voice thereof is difficult to identify, the classification of the dialog is suspended until the feature of the voiceprint is finalized.

However, the audio data transmitted in succession are subjected, by speech recognition, to conversion from the audio data (OD) to character data (MD) (in a conversion data portion in FIG. 8). Also script data 55 of the clinical report are generated in the conversion data portion.

Otherwise, clinical report script data 55 may be separately generated under a same file name P120. In such case, the data may be finally combined into a file under a correlation by the file name P120.

About at this stage, the doctor 1 specifies an image showing two persons in dialog, by a mouse or a key operation of the computer 3. The image data GD are taken by the imaging camera 5 at an interval of 10 or 20 seconds, and are transmitted together with the audio data OD from time to time to the server 10.

At this point, however, there are prepared interruption image data GDX from the imaging camera 5. The image data GD are fetched at an interval of 10 or 20 seconds, in order to save the data transmission time and the memory capacity.

The image data may be stored as a video signal if the communication line and the memory of the server 10 have an enough capacity, but an intermittent data transmission is more efficient in case many computers 3 are connected.

The audio signal OD are converted into data over the entire period, but such data are also compressed for a period of 3 to 5 seconds, for transmission to the server 10. In this manner, many doctors 1 can utilize the server 10 on time-shared basis.

Then the doctor 1 asks questions for medical interview to the patient 2. When the doctor 1 makes a speech such as “What is the matter with you?”, “What kind of symptoms do you have?” or “Where do you have pain?”, the server 10 recognizes, by speech recognition, that a stage of personal specification such as self introduction has been completed and a medical interview is going to start.

Consequently, the content of the speech of the doctor 1 is preferably standardized as a manual, in order to elevate the status recognition rate of the server 10. The patient 2 replies “I have a pain in the belly”, which the server 10 judges as “abdominal pain” by speech recognition.

However the server 10 stores “I have a pain in the belly” as the data OD, and separately enters a simplified expression “abdominal pain” in a symptom recording file data SHD.

When the doctor 1 speaks “Where and how is the pain?”, the server 10 recognizes the speech of the doctor 1 by the voice print, and judges as “inquiry on the position of the abdominal pain”. When the patient 2 speaks “A piercing pain at the upper left side, the server 10 forms a text “A piercing pain at the upper left side” by speech recognition.

Then the doctor 1 asks “When the pain started?” and the patient 2 answers “Since about noon yesterday”, and the dialog is assumed to continue in the following manner:

Doctor 1: Do you have nausea or retch?

Patient 2: A little.

Doctor 1: Do you feel ache after the meal, or before the meal?

Patient 2: Probably before the meal.

Doctor 1: Have you had this symptom before?

Patient 2: No, this is the first time.

Doctor 1: Does it ache severely?

Patient 2: Yes, fairly badly.

Doctor 1: What have you eaten for breakfast and lunch, yesterday?

Patient 2: For breakfast, I ate buttered toast, milk, vegetable juice and boiled eggs. For lunch, I ate a Hamburger steak at a nearby restaurant.

Doctor 1: Do you like eating hot or spicy foods, such as very hot curry? Also, do you smoke?

Patient 2: I do not like spicy foods. I smoke about 10 cigarettes a day.

Doctor 1: Do you like drinking? Also, is your work busy?

Patient 2: I like drinking, but I don't drink much. My work is rather busy lately and I am under considerable stress.

Doctor 1: Do you have a cold? Do you have a fever?

Patient 2: No, and I don't have a fever.

Doctor 1: Do you have anything else you feel bad?How is the passage? Aren't the feces black?

Patient 2: I feel retchy. Passage is okay. Color is normal.

Doctor 1: In your family, do you have anyone having stomach ulcer or stomach cancer?

Patient 2: No, no one.

Doctor 1: I will do the manual examination. Please lie down on the bed with your face up.

Patient 2: Yes.

Doctor 1: There is no stiffness or abnormality I can feel. Do you feel pain in this lower belly, or around the stomach pit, or in this area at the left side?

Patient 2: Oops! I feel severe pain around there.

Doctor 1: Okay, I understand. Please get up and sit down on the chair. Judging from the symptoms, it seems an acute gastritis. To make it sure, I recommend inspection with the gastro camera.

The inspection cannot be done today, so that let's do it on a later day. For today, I will prescribe a mucous membrane protector, an antalgic and a medicine for suppressing stomach secretion. As to the gastro camera, when it is convenient for you?

Patient 2: I am feeling very strong pain, but don't I need to worry?

Doctor 1: No, that is okay. As you do not seem to have experienced any stomach disease, you are feeling the pain very strongly. Also you are not vomiting blood, but, if you are worried, shall I check the functions of liver and pancreas by a blood test?

Patient 2: Yes, please. Can you do the gastro camera inspection tomorrow?

Doctor 1: I understand. I will reserve the gastro camera for tomorrow. Also I would like to have a blood sample, so please have a blood sample extracted at the blood sampling room before you go home.

(Now Doctor 1 makes a reservation for the gastro camera, a confirmation of the fee for the gastro camera, a procedure for blood sample extraction and a confirmation of the items to be tested; for example number of leukocytes, stomach and pancreas tumor markers, and GOT, GPT tests for liver.)

Now, I will confirm the result of today's diagnosis, please listen. Symptom: stimulative pain in the upper left side of the belly. Diagnosis: as a result of palpation and interview, an acute gastritis by stress is judged. Treatment: Stomach membrane protector, an antalgic for stomach pain and a gastric secretion suppressor are prescribed.

Others: To be reconfirmed by a blood test and a gastro camera inspection. How about this?

Patient 2: Yes, I understand.

Doctor 1: For today, please eat milk products such as milk or yogurt, and avoid stimulating foods such as alcoholic drinks or curry.

If possible, please eat something light to your stomach, such as porridge or noodles. Then, ask and follow instructions from the nurse in another room, before you go back.

After such dialog, the doctor 1 shifts the switch 4 from the active state to the OFF state.

In response to this signal, the data transmission from the audio microphone 6 and the imaging camera 5 to the server 10 is terminated. With this signal, the server 10 judges that a diagnosis has been terminated, and prints the foregoing dialog in the form of a clinical report 50 shown in FIG. 2.

Otherwise, such clinical report 50 is displayed on the computer 3, and the doctor 1, if agrees, instructs a printout by a key input or a mouse operation. The immediately outputted clinical report 50 is shown to the patient 2 and is given an approving signature 125 to further increase the value of the document.

If the patient 2 requests the clinical report 50, an additional printout may be made and handed to the patient 2. In this manner a compact and detailed file for storage is prepared, and the management of the references becomes easier also for the doctor. In addition, separately from the clinical report 50, there is outputted a printed sheet of the points for the medical insurance.

Such sheet bears the names of the doctor 1 and the patient 2, and is prepared with a check format for the treatment expenses determined for each hospital, for example an initial visit fee, a diagnosis fee, an inspection fee, a treatment fee, and a prescription fee (or a medicine fee in case the medicine is received in the hospital), with checks inscribed in the corresponding items.

Now there will be given an explanation on the script data 55 of the clinical report 50 shown in FIG. 2. In the process flow explained above, the server 10 extracts the items necessary for the description of the clinical report 50 shown in FIG. 2, through the speech recognition system and the script data preparation system.

Referring to FIG. 2, in P1, the name of the doctor 1 obtained from the data TD is placed, and, in P2, the name of the patient 2 obtained from the data TBD is placed. It may also be possible to show a front photograph of the patient, an address, an age, a telephone number etc. P101 contains the time and date, and the location of the dialog.

The inputted time is the time of activation of the switch 4, measured by the computer 3 or the server 10, and the inputted location is the data of the hospital or the place of diagnosis registered in the computer 3.

A column P102 includes the image data GDX taken by the doctor 1. A column P11 includes another image data GDX′ designated by the doctor 1. It may be an X-ray photograph or a CT image separately taken, and may be in plural units.

A column P121 for symptom includes the symptom data SHD recognized by the server 10, which however are automatically replaced by “stimulative pain in the upper left part of the belly” according to the final diagnosis (foregoing underlined part) of the doctor 1.

In a column P122 for the medical interview, the server 10 recognizes the content of the inquiries of the doctor 1 and automatically arranges a list such as “time of generation, medical history, life habits, complications, . . . ”.

In a column P123 for diagnosis, the diagnosis in the speech of the doctor 1 (underlined part) is entered, thereby completing the format of the clinical report. Then, in a part P130, all the speeches of the dialog are recorded. This part need not be in standard Japanese but can be in alphabets, English, German etc.

It may also be in audio code data or in ASKII codes. Stated differently the converted audio character data OD are described in this part. The audio data MD and the image data GD, GDX constituting the basic data are not described on the paper 50 but stored only in the server 10.

It is preferably that this part is positioned on the rear surface of the clinical report, because the clinical report can be made compact and clear. It also helps to effectively utilize the paper space.

Through the above-described procedure, the script data 55 are prepared, transmitted to the computer 3 and printed by the printer 7. Thereafter the printed sheet 50 may be shown to the patient 2 and may be given an approving signature by the patient 2 in a column P125 for further assurance. However it is also possible to dispense with the column P125.

Also any item that the doctor 1 can confirm from past experience, cases or symptoms even not spoken, or that the doctor 1 cannot directly inform the patient 2, may be manually described by the doctor 1 in a remark column P131 on the clinical report 50.

Such description, being not mutually agreed, is not stored in the data of the server 10. Otherwise, such part may be inputted, after the patient 2 retires, in the server 10 as a secret file P120′ by turning on the switch 4.

In such case, a statement “confidential file” or “secret file” is made to the camera 5 and the audio microphone 6, and the server 10 recognizes such statement and prepares a secret file P120′ in relation to the file P120. Otherwise, the data of the part described by the doctor 1 may be inputted by reading with a scanner, or such data may be entered by a keyboard operation. Such data are stored in the server 10 under a file name P120.

Such flow allows to prepare a part, which could not be described manually by the doctor 1, more detailedly and simply even with a photograph. Also the association of a secret file allows to execute diagnosis or treatment based on the past experience or the skill of the doctor, and also facilitates preparation of a presentation material for example at an academic conference.

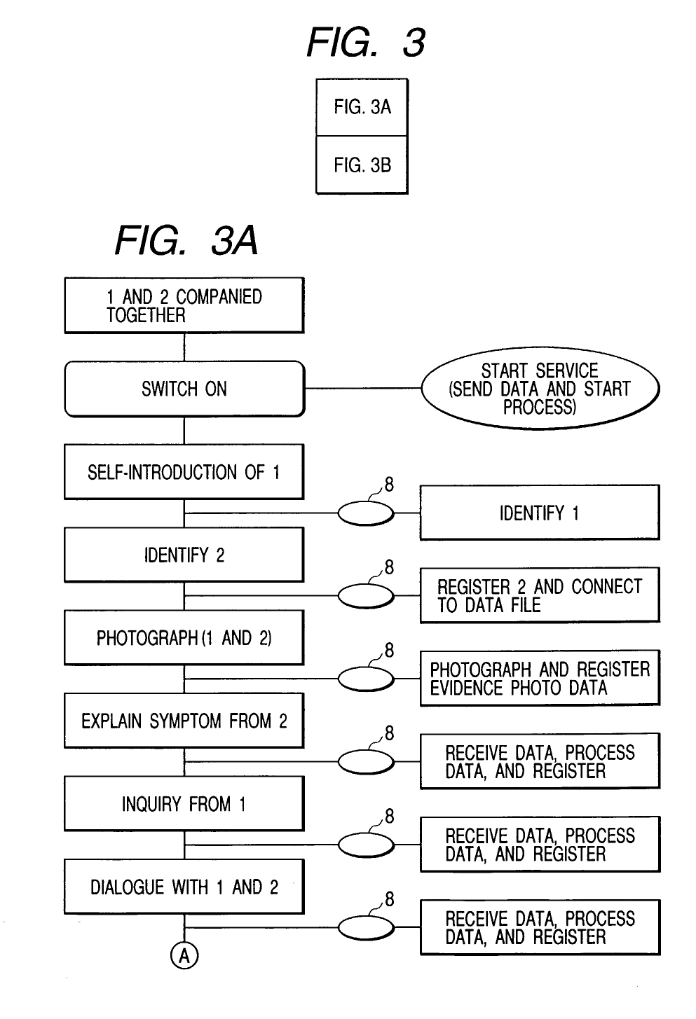

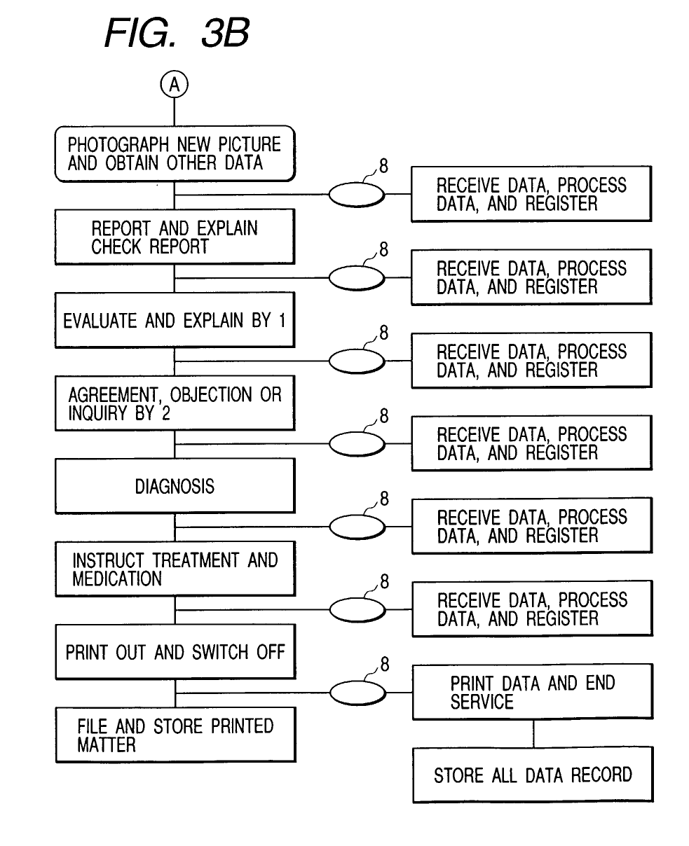

FIGS. 3A and 3B are flow charts showing an example of the process flow. The script data 50 of the clinical report may be handed and given to the patient 2, but, in such case, there is required an additional printout and the expenses for such printout and data preparation have to be borne by the patient 2.

There is also required an additional time (about 20 to 40 seconds), and, in order to alleviate such waste in time and expenses on the patient 2, such script data 55 may be transmitted to the computer 2′ of the patient 2 through the internet 8.

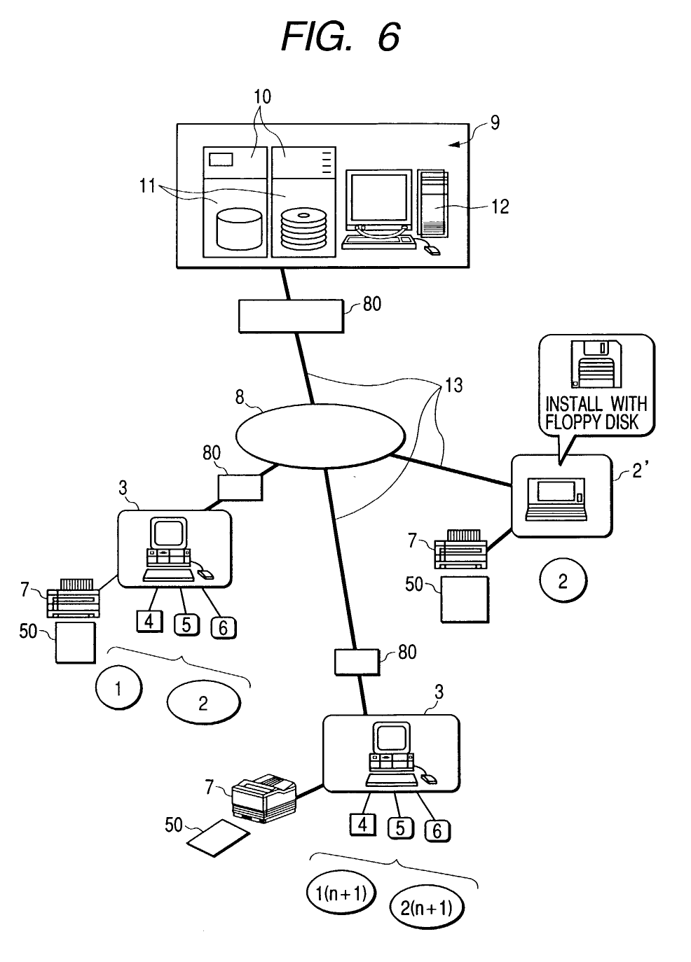

FIG. 6 shows a configuration including an apparatus 80 for transmitting and receiving data under enciphering. The apparatus is an enciphering apparatus called VPN, and it is preferred that the server 10 is provided with Fort Knox of Alcatel Inc. U.S.A while the computer 3 of the doctor 1 is provided with Mucho-E/EV of Furukawa Denko Co.

It is also desirable that the computer 2′ of the patient 2 is provided with the Mucho-E/EV of Furukawa Denko, but, if a slower processing speed is tolerable, a VPN deciphering software may be introduced in a client server system through a floppy disk or a CD disk.

The data are transmitted by the doctor 1, based on an internet address (TCPIP) or an E-mail address of the patient 2. Otherwise, the data 55 may be stored in an IC card, a magnetooptical disk or an optical disk and hand delivered to the patient.

However, as the part of the secret file P120′ is not agreed by the both persons, it is not transferred as a printed clinical report to the patient, nor transmitted for example by the internet, nor stored in an IC card or the like.

This is because a medical treatment is based on a mutual agreement of the doctor 1 and the patient 2 and is only ensured by the statement of the patient 2 or a fact (data) established by specific test, while the purpose of the present embodiment is to avoid an error in the medical treatment or to avoid a medical treatment lower than an ordinary level, and, in order to receive a medical treatment of a higher level, it is desirable to receive the treatment by a doctor of a higher skill.

The doctor of a higher skill can recognize symptoms not stated by the patient or delicate data not found in the inspection tests, and can utilize such factors in the treatment. Such factor increases the fame and popularity of the doctor and is stored as the secret file P120′ which is only observable by the doctor himself.

Therefore, a doctor 1 of a higher skill utilizes such secret file P120′ more frequently, and can apply a treatment closer to the standpoint of the patient 2. Also, it is not essential to prepare such secret file P120′.

However, in case of an unexpected accident in the medical treatment, the secret file P120′ clearly ensures the path leading to such medical treatment, so that the doctor can safely execute the treatment.

Stated differently, the file P120 is an ordinary clinical report file, while the secret file P120′ is a clinical report file of an upper level.

(Specific Configuration 2)

In the foregoing there has been explained a configuration in case the patient 2 visits the doctor 1 for the first time, and, in the following there will be explained a configuration in case the patient 2 visits again the doctor 1. There is assumed a situation where the patient 2 visits again after the photographing with the gastro camera and the data of the blood tests are ready.

The preparation of the data file and the flow thereof in such case will be explained with reference to FIG. 8 showing a re-examination situation. For receiving the aforementioned service, the doctor 1 turns on the switch 4.

At this point, a current file is prepared regarding the patient 2 as a first visiting patient, and the audio data OD and the image data GD are also prepared as a current file. Thereafter, when the patient 2 declares the name, the server 10 searches the past clinical report data file P120 of the patient 2 when treated in this hospital or by the doctor 1.

If the past data file P120 is present at this stage, the script data 55 in the latest data file P120 are displayed on the computer 3 of the doctor 1. If desired, the doctor 1 can print out the data by a key operation.

Also, if the presence of the secret file P120′ is displayed on the computer 3, the doctor 1 can display and confirm such secret file while it is not observable to the patient 2. In this manner the doctor 1 can confirm the status of the patient 2 at present and in the past.

At this stage, the patient 2 is identified as a re-visiting patient. In practice, it is usual that the patient is classified as a first visiting patient or a re-visiting patient at the reception of the hospital and that the clinical report 50 of the patient 2 is delivered to the doctor 1 in advance.

However, the above-described procedure allows to prepare the clinical report 50 efficiently, in case the nurses or the hospital clerks are reduced in order to decrease the labor cost of the hospital or to improve the efficiency thereof. In this manner it is rendered possible to decrease the toils of storage and handling of the clinical report and to achieve the diagnosis and the treatment in a very efficient manner. It is assumed that a following dialog is initiated thereafter.

Doctor 1: How are the symptoms since last time?

Patient 2: Pain has considerably decreased by the medicines, but a blunt pain still remains, I occasionally feed strong pains.

Doctor 1: Results of the endoscope and the blood tests are here. Based on the results, the internal wall of the stomach shows inflammation, with hemorrhage from two points. Also, as you will see, the stomach wall shows spot-like traces of cured inflammations.

Judging from these, it seems that these symptoms were also present before, but recovered in the course. In the past, the pains would not be bad.

(The doctor 1 inputs the photograph of the endoscope and the results of the blood tests by a scanner and transmits them to the server 10. If the level of the camera 5 is acceptable, these data may be taken by the camera 5 and transmitted as the data GDX.)

Patient 2: Well, I remember I had slight pains in the stomach but I recovered soon.

Doctor 1: Also the results of the blood test are available. There is no problem in the liver, kidney and pancreas, and I do not see any abnormality in the blood. Problem seems to be only in the stomach.

Judging from the state of the stomach wall, it is a chronic gastritis. As the chronic gastritis is cause by pirroli bacter, please take antibiotics for eliminating the pirroli bacter after each meal for about 5 days. Then you will get better.

Also refrain from drinking, and, for the meals, each easily digestible foods. Also the entire stomach wall seems reddish, like inflammation, indicating that the stomach is weak. Please take enough sleep, and decrease the amount of work to avoid stress.

Patient 2: Yes, I understand. I am relieved to know that the trouble is limited to the stomach.

Doctor 1: It is not that the trouble is limited to the stomach, since the tests are limited to the liver, pancreas, kidney and blood tests. I am not saying that the lung, intestine and other parts have no problem. Please do not misunderstand. And, if you do not get better, please come again one week later.

Also, when you take the medicine, the stomach pain will vanish in about two days, but you must keep taking it for five days. Remember that the complete treatment cannot be reached unless you keep taking the medicine until the pirroli bacter are completely eliminated.

Patient 2: Yes, I understand.

Doctor 1: Then, I will read the diagnosis, please listen. Symptom: Change of stimulative pain in the upper left part of the belly to blunt pain by medicine prescription. Diagnosis: Judged as chronic gastritis by gastric endoscope and blood tests.

Treatment: Prescription of the gastric mucous membrane protector and the antibiotics against pirroli bacter for 5 days. Others: Instruction to reduce drinking and to take easily digestible meals. Is this okay?

Patient 2: Yes, I understand.

After such dialog, the doctor 1 turns off the switch 4. In response, the server 10 positions the script data 55 in a mode as shown in FIG. 2. The image data of an endoscope photograph of the stomach and a table showing the results of the blood tests are placed in a portion P111 in FIG. 2.

Then, such data 55 are added after the previous data file P120 and are stored as the latest clinical report file P120 of the patient 2. The audio data MD and the image data GD are similarly added at the same time and are stored.

More specifically, as shown in FIG. 8, the clinical report file P120 of the patient 2 is extracted and divided into the conversion data portion, the portion of the original audio data MD and the original image data GD, and the secret file portion, and the data at the re-examination are added to each portion.

Thereafter, these data portions are combined and stored under the file name P120. Naturally, the script data 55 are positioned continuously and formed into a file in the conversion data portion.

Then, the clinical report script data 55 are printed by the printer 7 of the computer 3 of the doctor 1, as the clinical report 50. The printed portion is limited to the newly prepared script data 55, and the previous portion is naturally not printed.

If the patient 2 desires, the clinical report script data 55 may be transmitted to the computer 2′ of the patient 2 through the internet 8, or may be recorded in the IC card of the patient 2 and handed thereto. Thereafter, after the patient 2 retires, the doctor 1 prepares the secret file P120′.

The doctor 1 turns on the switch 4 and speaks out “secret file P120′” to the camera 5 and the microphone 6 or executes a key operation, in order to prepare the secret file P120′.

The content is as follows: “As the patient stated last time that there were no gastritis nor stomach pain in the past, prescription was made for the ordinary gastritis, but the test results indicate a chronic gastritis, seemingly repeated from several years ago.

It can be judged as a chronic gastritis by pirroli bacter. Judging from the state of the stomach wall, recidivation will not occur for about an year but is highly possible in about two years. It will be better for the patient 2 to contact him after about an year and a half, in order to recommend re-examination. End.”

The doctor 1 then turns off the switch 4. The server 10 prepares the secret file P120′ in relation to the clinical report data file P120, and stores such file by jointing after the secret file P120′ within the aforementioned file P120.

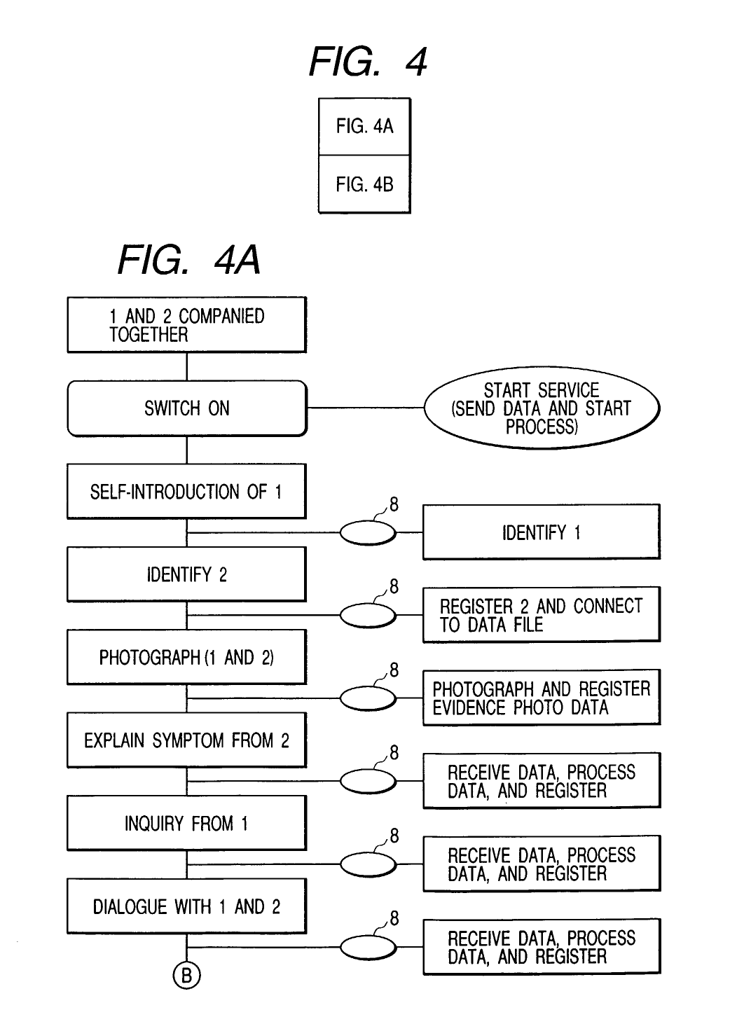

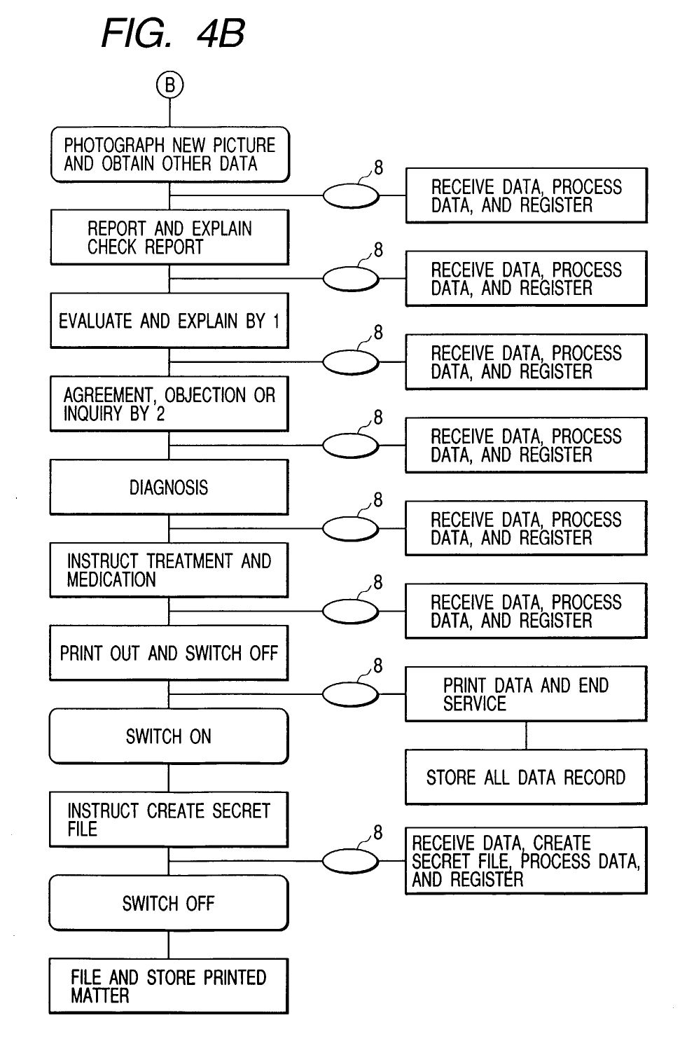

Then the doctor 1 prepares a registration for unlocking the secret file P120′ by the face and the audio data of the doctor 1, and terminates the service. FIGS. 4A and 4B are flow charts for the preparation of the secret file.

The unlocking of the clinical report data file P120 is possible to the authorized doctor, the related hospital personnel, the patient 2 and the authorized relatives thereof, the legal court or the authorized insurance company, and the clinical report data file P120 can therefore be viewed in case of an accident or a lawsuit.

However the secret file P120′ can only be unlocked by the doctor 1, nobody else can unlock and see it. It is also desirable that the secret file P120′ is deleted when the death of the doctor 1 is confirmed.

Since the storage period of the clinical report is basically 5 years, the clinical report data file P120 and the secret file P120′ are deleted after the lapse of 5 years from the date of first examination, unless the medical treatment is continued under a same disease name.

However, if the doctor 1 wishes to construct clinical data of a person over a long period, the files may also be stored for a necessary period after such intention is informed to an operating organization 9 and under a consent thereof.

Furthermore, the doctor 1 may execute a treatment or other instructions to the patient 2 through the internet 8. For example, in the aforementioned configuration 1, there can be made an instruction not to take any food on the day of the inspection with the gastro endoscope, a reconfirmation of the date of inspection, an instruction how to take the medicine or a confirmation whether the patient securely takes the medicine, or an instruction on daily drinking or meals.

In the aforementioned configuration 2, there may be made an instruction and a confirmation to take the antibiotics and the stomach wall protector after every meal and to take easily digestible meals. In this manner there can be anticipated secure recovery of the patient 2.

Further, the present invention is applicable not only to the relation between a doctor and a patient, but also to situations making various transactions or providing various services in an enclosed environment.

For example, it is applicable to a lawyer and a client thereof, a financial planner and a client thereof, or a policeman and a suspect.

Also, even in case a nurse or another attendee is present, if such person has to take the standpoint of either side, the situation can be regarded as an enclosed environment, so that the present invention is suitably applicable.

(Specific Configuration 3)

There is assumed a case where a young female patient 2 having a chest pain visits a doctor 1. As explained in the foregoing, the doctor 1 turns on the computer 3 and turns on the switch 4, thereby activating the camera 5 and the audio microphone 6.

After the first stage of entering the image data GD including the patient 2 and the doctor 1, the doctor 1 asks the patient 2 to remove the clothing from the upper body, for the purpose of diagnosis. From the standpoint of the patient 2, it is not desirable that the camera 5 continues to transmit the image data GD to the server 10, even on time-shared basis.

It is also not desirable that such data are stored in the server 10. Therefore, the server 10 executes automatic recognition on the transmitted image data GD, and eliminates the image data of the chest portion of the female patient 2 by image recognition.

Otherwise, it stores the image data after an obscuring process (mosaic process). Such process is based on a mutual agreement of the doctor 1 and the patient 2, and may be dispensed with if the patient 2 does not particularly request.

It is most preferable that, by a key operation of the doctor 1 on the computer 3, the computer 3 transmits the image data GD to the server 10 after executing an image processing such as a partial deletion or an obscuring process.

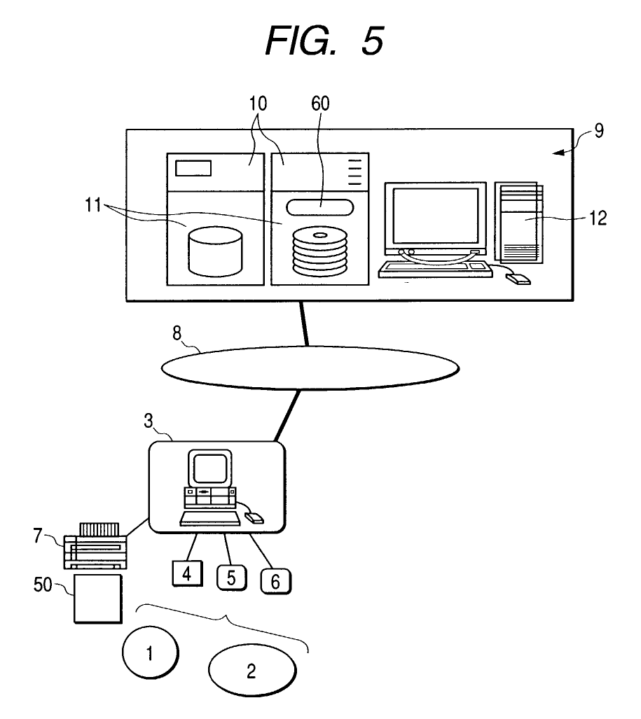

FIG. 5 is a schematic view showing such configuration. The doctor 1 executes a key operation for privacy protection. In response to such a signal, the server 10 activates an image processing unit 60 whereby the server 10 recognizes the chest part of the female in the image data GD from the camera 5 by an image recognition process, and executes a partial deletion or an obscuring process.

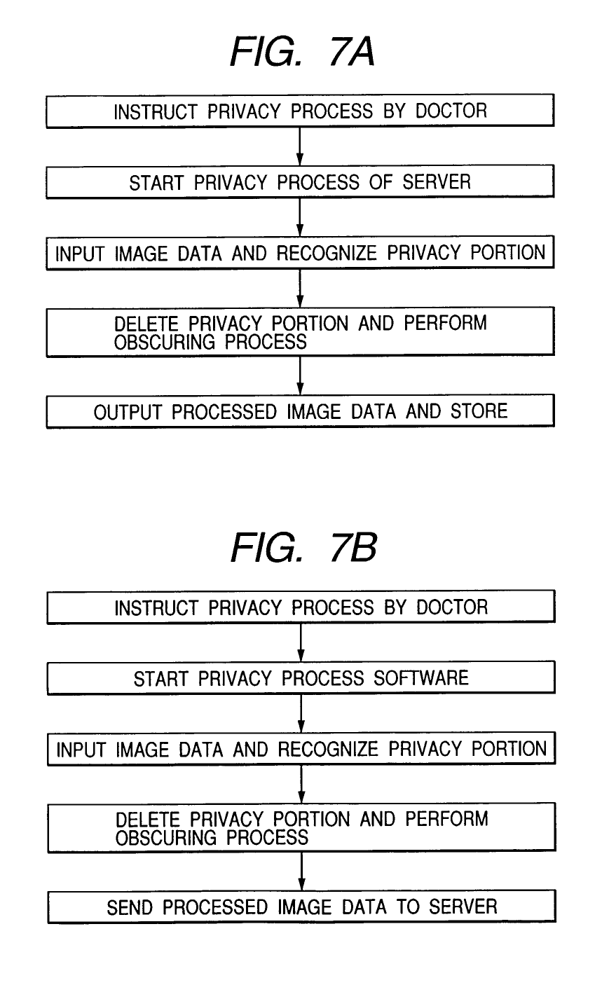

Then the image data GD are stored. FIG. 7A is a flow chart of the process in such case. If possible, the image processing unit (image processing board) 60 is desirably provided in the computer 3 of the doctor 1.

Such process is applicable in case of a disease in the lung or in the bronchus, but, in case of a breast cancer or a dermatitis in the chest, such process merely hides the diseased part and is therefore not acceptable.

In such case, if the face and the diseased part of the female patient are entered in the data of a same image, either one is deleted or obscured in order to alleviate the uneasiness of the patient as far as possible.

Such process is applicable also to a diagnosis of a lower belly in obstetrics, gynaecology and urology. It is however more desirable that the doctor 1 so operates the camera 5 as to enlarge the diseased part only, thereby showing the symptom or the status in more details.

In such case, by an operation of the doctor 1, the image data GD are transmitted as designated image data GDX to the server 10. FIG. 7B is a schematic flow chart showing the process sequence in the present case. In this manner it is possible to eliminate the uneasiness of the patient 2 and to establish the reliable protection of privacy.

(Specific Configuration 4)

In case plural patients 2 having diarrhea visit the doctor 1, the doctor 1 can request, in addition to ordinary medical diagnosis and treatment, an investigation on the status of occurrence of diarrhea symptom to the operating organization 9 of the server 10 either through the computer 3 or through the telephone.

The doctor 1 can see and refer to the clinical report data 55 of the patients 2 who have been diagnosed by the doctor 1 or whose data the doctor 1 is authorized to see, but is unable to confirm the status of occurrence at other doctors or in other hospitals.

Therefore, the doctor 1 tries to obtain data by requesting an investigation to the operating organization 9. However, even for the operating organization 9, it is not possible to freely review the clinical report data 55 including the privacy of the patient.

Consequently, the operating organization activates a word search file to retrieve registration of a disease name or a symptom, not involving the privacy, within the data of a specified period (for example a latest week) in the server 10 managed by the organization.

For example, in case of a diarrhea symptom, a word “diarrhea” is entered and searched by the server 10, and only the number of occurrences is displayed under a classification by the doctor or the hospital in charge.

In this manner, the status of the area managed by the server 10 within the latest week can be confirmed. It is also possible to obtain data tracing the occurrence in time, by making searches for yesterday, two days ago and so on.

The operating organization 9 transmits such data to the doctor 1, who can thus confirm the status of occurrence. If the data are not particularly abnormal, the situation is handled as a temporary situation.

On the other hand, if the data are judged abnormal, the operating organization 9 reports an abnormal situation to the health office of the area, thereby enabling a prompt response. Also by constantly monitoring an infectious disease or a symptom that is apt to occur collectively in the above-described manner, there is enabled a prompt response to the infectious disease.

In this manner, the safety of the area can be secured while maintaining the privacy of the individuals. In the foregoing description, the server 10 is assumed to be located close to the doctor or the hospital, but it can in fact be located in any place that can be contacted by communication.

There is particularly preferred a location that has a stable electric power supply, is stable in local security, has a low possibility of calamities and has a system and a facility for inspection, maintenance and urgent situation.

Furthermore, the server 10 is preferably not composed of a single server but of plural dispersed servers and is provided with a back-up server.

These clinical report data P120 and the script data 55 are basically deleted or destroyed after a storage period of about five years, but such data, being a precious heritage of mankind, particularly that specifying individuals, have to be safely stored, and having a possibility of leading to the development of a new treatment method or a new efficient medicine if processed by a computer with a high speed processor when such technology is developed years later, are preferably semi-perpetually.

This is because, for a special or rare disease which is limited in the number of cases, an effective treatment is difficult to find due to the limited number of data, a data file compiling the data from the past, if present, leads to the finding of a more efficient method of treatment.

The embodiment explained in the foregoing allows to solve various problems arising between a specified person and an unspecified person having a relation thereto:

1) A dialog between a doctor and a patient, a diagnosis and a treatment thereafter are stored as data by an external third person, and the dialog is converted into a text by speech recognition and is immediately and detailedly printed as a clinical report, whereby the clinical report can be immediately disclosed to the patient.

As the clinical report is hand-written but is printed, there may result a concern in the patient that the clinical report is forged or altered, but such concern is eliminated by the storage of the data by a third person. In addition, since the content of the dialog and the image are stored in an organization operated by the third person, they have a higher value as an objective evidence in the legal court or in case of lawsuit;

2) In the course of the dialog, the content of the treatment for the patient is automatically recognized by speech recognition, and is used for calculating the expenses for the treatment for transmission to the accounting division, whereby an efficient operation in time can be realized;

3) Also such data to be printed or all the data may be recorded, at a terminal of the doctor, in a recording medium such as a memory card of the patient and brought back, or may be transmitted to a personal terminal of the patient through the internet, whereby the patient is enabled to personally hold the data;

4) Further, by preparing a secret file in relation to the clinical report file of the patient and rendering such secret file unavailable and unchangeable except for the doctor in charge, the doctor can record a consideration based on the past experience without its medical know-how being disclosed to others;

5) Such system will require an enormous expense for maintenance and management, but a shared use by plural specified persons allows to maintain the expense for each person at a low level;

6) Such system operated by the third person may count an occurring event without disclosing the individual name and generates statistics on such event in each area, thereby promptly discovering the occurrence or expansion of such event and enabling an early countermeasure thereto;

7) Also a data portion involving the privacy of the patient may be partially deleted or obscured based on an agreement between the doctor and the patient, whereby the privacy of the patient can be securely retained; and

8) Also for a patient to whom the clinical report data are transmitted through the internet, the address of the patient can be used for giving an instruction on a medical test, a method of administering a medicine or a method of taking meals, thereby expediting the recovery and remedy of the patient.

Although the present invention has been described in its preferred form with a certain degree of particularity, many apparently widely different embodiments of the invention can be made without departing from the spirit and the scope thereof. It is to be understood that the invention is not limited to the specific embodiments thereof except as defined in the appended claims.

What is claimed is:

1. A dialog data recording method in a system in which a computer terminal of a person, capable of entering audio data and an image and of data printing, is capable of communicating with a server managed by a third person and having a large-capacity memory apparatus, the method comprising steps of:
transmitting dialog data, containing an image and audio data in a dialog between said person and another person, from the computer terminal of said person to said server for storage in said large-capacity memory apparatus;
recognizing and converting the audio data in said dialog data into text data;
generating script data based on said text data; and
printing said script data by the computer terminal of said person.

2. A dialog data recording method according to claim 1, wherein said generating step generates said script data based on said text data and image data relating to said unspecified person.

3. A dialog data recording method according to claim 1, further comprising steps of:
generating agreement data indicating that said person and another person agree to the content of said printed script data; and
transmitting said agreement data to said server for storage together with said dialog data in said large-capacity memory apparatus.

4. A dialog data recording method according to claim 3, wherein said agreement data are an image and audio data of a behavior representing an agreement, or an image of a signature or a stamp on said printed script data.

5. A dialog data recording method according to claim 1, wherein, in said transmission step, a secret file observable only by said specified person is attached to said dialog data.

6. A dialog data recording method according to claim 1, wherein, after said specified person and another person agree to the content of said printed script data, said script data are transferred to said another person or a representative person thereof by transmission or by recording in a recording medium.

7. A dialog data recording method according to claim 1, wherein, in said transmission step, the data are transmitted under enciphering.

8. A dialog data recording method according to claim 1, wherein a cipher key is set for said image and audio data or for said script data, thereby limiting a person who can observe said data.

9. A dialog data recording method according to claim 2, wherein said image data are concealed by deletion or a obscuring process in a specified part, and are transmitted after such concealing.

10. A dialog data recording method according to claim 1, wherein said script data include a date and a time, a location, and names of the persons executing said dialog.

11. A dialog data recording method according to claim 10, wherein said script data further include an image of the persons executing said dialog.

12. A dialog data recording method according to claim 10, wherein said script data are generated by identifying a speech of each of the persons executing said dialog.

13. A dialog data recording method according to claim 1, wherein, in said printing step, all the speeches of said dialog or data obtained by converting said dialog are recorded on a rear surface of a sheet.

14. A dialog data recording method according to claim 1, wherein said person is a person providing a business service, and another person executing the dialog with said person is a general person receiving said business service.

15. A dialog data recording method according to claim 1, wherein said person is a person executing a medical action, and another person executing the dialog with said person is a patient or a representative person thereof.

16. A dialog data recording method according to claim 1, wherein said script data are generated by extracting and editing specified items from said text data.
